(19) United States
(12) Patent Application Publication
(10) Pub. No.: US 2003/0120537 A1
(43) Pub. Date: Jun. 26, 2003

(54) Method for enhancing job performance of marginal employees

(76) Inventors: Jan Marie Desanti, Augusta, GA (US); Rachel Susan Lieberman, Ridgefield, CT (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/023,993

(22) Filed: Dec. 21, 2001

(51) Int. Cl. G06F 17/60

(52) U.S. Cl. 705/11

(57) ABSTRACT

A method for enhancing the performance of marginal employees, wherein the employees are treated objectively consistently while the marginal employee and the employer maintain good personal communications. The method comprises determining whether the employee lacks the motivation or the ability to perform adequately, establishing goals and a time period for the marginal employee to achieve enhanced performance, and evaluating whether or not the method was effectively executed before employer decides whether to retain, terminate or reassign the employee. The method further comprises documentation of the execution of the method so that the employer may make consistent and well informed decisions.

### FIELD OF THE INVENTION

The present invention relates generally to methods for managing human resources. More particularly, the invention pertains to enhancing the job performance of marginal employees.

### BACKGROUND OF THE INVENTION

Every employer desires to have their employees perform adequately at their jobs. Inadequate job performance by an employee makes other employees' jobs more difficult and decreases the likelihood of the success of the employer's projects. For an employee's performance to be adequate, the employee must have the ability and the motivation to perform the job. Where a marginal employee does not have sufficient ability or motivation to perform the job, the employer must find ways to improve such marginal employee's ability and motivation so that the job is adequately performed. Additionally, the employer may be faced with trying to separate an employee whose performance will always be inadequate from employees who do perform adequately. Moreover, employers need to be able to differentiate between an employee whose performance is not adequate even given sufficient training and resources and employees who have not been provided with the resources or motivation necessary for adequate performance. Maintaining fair and consistent treatment among marginal employees is another goal of employers. A well-documented history of a job performance of a marginal employee enables an employer to more fairly and appropriately handle decisions regarding marginal employees and to maintain consistent treatment among the employees.

The problem in the prior art is that computerized and automated methods of addressing inadequate performance by an employee fail to relate to the marginal employee in a personal manner. Prior methods that aim to treat employees consistently and objectively quantify performance lack the interpersonal communication that creates accountability and motivation to remedy performance inadequacies.

### SUMMARY OF THE INVENTION

The present invention overcomes these drawbacks in existing systems and methods.

The invention enhances the job performance of a marginal employee so that he adequately fulfills his job requirements.

The method of the invention may be used to enhance interpersonal communications between a marginal employee and his employer.

The method of the invention may be used to identify and provide training for a marginal employee without the ability to perform adequately.

The method of the invention may be used to identify and provide training for a marginal employee without the motivation to perform adequately.

The method of the invention may be used to manage a marginal employee in a manner consistent with the treatment of other marginal employees.

The method of the invention may be use to document the communication with, treatment of, and performance patterns of a marginal employee.

The method of the invention may be used to enable an employer of a marginal employee to make a fair and educated decision whether to retain, terminate, or reassign the marginal employee.

Accordingly, the present invention overcomes the above-mentioned drawbacks and deficiencies of prior systems and processes by providing a method for enhancing the performance of a marginal employee comprising the steps of (a) an employer identifying a marginal employee; (b) the employer determining whether the employee lacks motivation or lacks an ability to meet one or more job requirements; (c) the employer identifying further training that would give the marginal employee the ability to meet the one or more job requirements; (d) the employer defining at least one goal for enhanced performance of the marginal employee; (e) the employer defining a time period within which the marginal employee should achieve the at least one goal for enhanced performance; (f) the marginal employee making a record of the marginal employee's understanding of the one or more job requirements; (g) the employer discussing with the marginal employee the one or more job requirements and the marginal employee's understanding of the one or more job requirements; (h) the employer communicating to the marginal employee the at least one goal for enhanced performance and the time period within which the marginal employee should achieve the at least one goal for enhanced performance; (i) the employer communicating to the marginal employee one or more possible outcomes; (j) the employer obtaining from the marginal employee an acknowledgement of the at least one goal for enhanced performance and the time period within which the marginal employee should achieve the at least one goal for enhanced performance; (k) the employer making available the further training that would give the marginal employee the ability to meet the one or more job requirements; (l) the employer monitoring the marginal employee's performance over the time period; (m) the employer determining whether the at least one goal for enhanced performance was achieved during the time period; (n) the employer determining whether an extension of the time period for the employee to achieve the at least one goal for enhanced performance is appropriate; and (o) the employer determining an appropriate outcome for the marginal employee.

### BRIEF DESCRIPTION OF THE DRAWINGS

FIG. 1 is a flow diagram showing the steps performed in one embodiment of the method of the present invention.

FIG. 2 shows a worksheet for the employer to determine whether an extension of the time period for the marginal employee to achieve enhanced performance is appropriate.

### DETAILED DESCRIPTION OF THE INVENTION

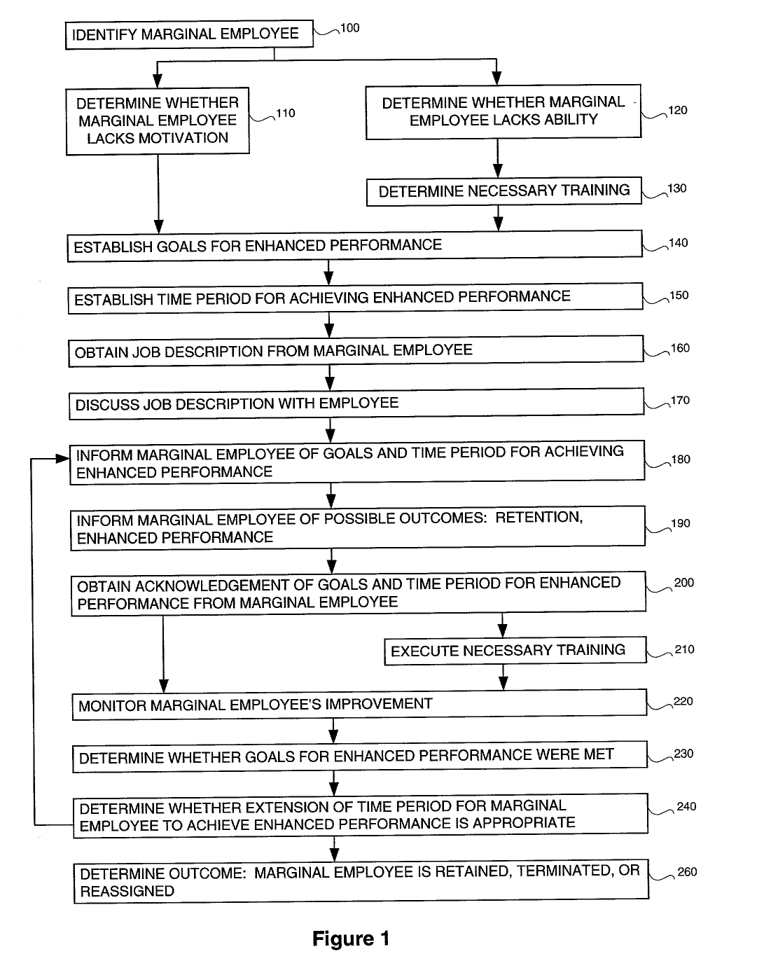

FIG. 1 is a flow diagram showing the steps performed in one embodiment of the method of the present invention. At step 100, an employer may identify a marginal employee. The employer may determine, at step 110, whether the marginal employee lacks motivation to perform his job adequately. At step 120, the marginal employer may also determine whether the employee has the ability to perform his job adequately. In one embodiment of the present invention, the marginal employee's ability includes his training and skills. If the marginal employee lacks the ability to perform his job adequately, the employer may identify training likely to enhance the marginal employee's ability at step 130. At step 140, the marginal employee's lack of motivation, if any exists, and the marginal employee's lack of ability, if any exists, may be used to establish at least one goal for the enhanced performance of the marginal employee. An appropriate time period for the marginal employee's achievement of the at least one goal may be established at step 150.

According to an embodiment of the present invention, at step 160, the employer may obtain from the marginal employee a job description. The job description is used to document the marginal employee's understanding of the requirements for adequate performance of the job the marginal employee currently fills. At step 170, the employer may discuss with the marginal employee the job description, specifically addressing any areas where the employer's expectations are not met by the marginal employee's job description.

According to an embodiment of the invention, at step 180, the employer may inform the marginal employee of the previously established goals for enhanced performance and the time period within which the marginal employee should achieve the previously established goals. At step 190, the employer may discuss with the marginal employee all possible outcomes at the conclusion of the time period, including retention at the marginal employee's present position with improvement, termination of the marginal employee, or reassignment of the marginal employee to a position better matched to the marginal employee's abilities and motivation, if such a position is available. At step 200, the employer may obtain an acknowledgement from the marginal employee of the goals for enhanced performance and the time period set for the marginal employee to achieve those goals. In an embodiment of the present invention, the acknowledgement is in writing and further includes documentation of the possible outcomes at the end of the time period.

According to an embodiment of the present invention, if the marginal employee lacks the ability to perform his job adequately, during the time period, the employer may make available the training likely to enhance the marginal employee's ability to perform adequately. At step 220, the employer may monitor the marginal employee's performance over the course of the time period.

Upon the expiration of the established time period for the marginal employee to achieve enhanced performance, at step 230, the employer may determine whether the marginal employee has achieved the goals for enhanced performance. According to an embodiment of the present invention, if the marginal employee has achieved the goals for enhanced performance, the employee may be retained at his current job assignment. If the marginal employee has not achieved the goals for enhanced performance during the time period, the employer may decide whether an extension of the time period for the marginal employee to achieve enhanced performance is appropriate at step 240.

If the employer decides, at step 240, that an extension of the time period is appropriate, then the employer may return to step 180 where the employer may inform the marginal employee of the extension of the time period for achieving enhanced performance and the goals for enhanced performance for the extended time period. If the employer decides at step 240 that an extension of the time period is not appropriate, then the employer may proceed to step 260, where the employer may decide whether to retain the marginal employee at the present position, reassign the marginal employee to a position better suited to the employee's abilities and motivation level, or terminate the marginal employee, if such a position is available.

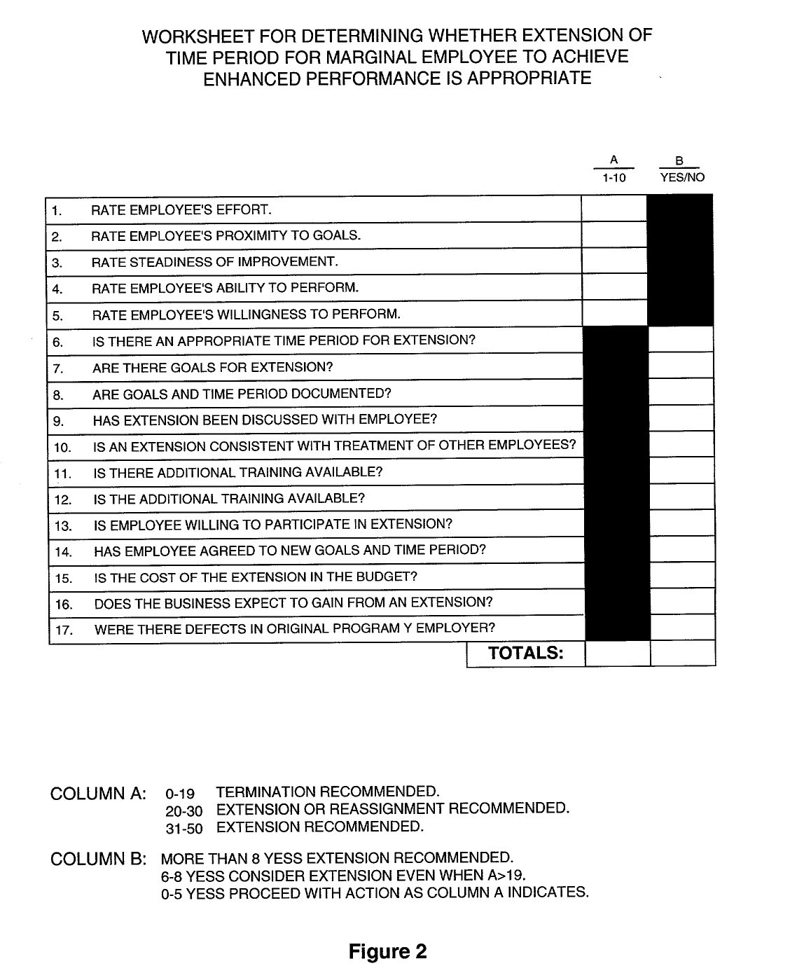

FIG. 2 shows a worksheet an employer may use to determine whether an extension of the time period within which the marginal employee should achieve enhanced performance is appropriate. In column A, the employer is asked to rate the marginal employee's effort, the marginal employee's proximity to achieving the set goals, the marginal employee's steadiness of improvement in performance and the marginal employee's ability and willingness to perform the job adequately on a numerical scale, according to an embodiment of the present invention. As shown at the bottom of the worksheet, the employer may add those numbers, compare the total of the added numbers with those totals for other employees and decide upon an initial recommendation.

According to an embodiment of the present invention, the employer may then answer the following yes/no questions in column B of the worksheet:

(1) Did you determine a specific time period for an extension?

(2) Are there defined goals for the extended time period?

(3) Are the extended time period and the goals for such documented?

(4) Have the extended time period and the goals for such been discussed with the marginal employee?

(5) Would an extension of the time period be consistent with the employer's treatment of other employees?

(6) Is additional training necessary?

(7) Is the necessary additional training available?

(8) Is the marginal employee willing to participate in an extended time period for achieving enhanced performance?

(9) Has the marginal employee agreed to the extended time period and the goals for such?

(10) Does the employer have the resources necessary for the time period extension?

(11) Does the employer expect to gain from an extension of the time period?

(12) Were there defects in the execution of the original time period on the part of the employer?

According to an embodiment of the present invention, the number of yes answers to the above questions may be totaled. In an alternate embodiment of the present invention the number of no answers to the above questions may be totaled. The employer may decide to proceed with the initial recommendation, or recommend an alternative action to the initial recommendation based upon the total number of “yes” or “no” answers in column B.

While the foregoing description includes details and specificities, it should be understood that such details and specificities are not to be interpreted as limitations of the present invention. Many modifications to the embodiments described above can be made without departing from the spirit and scope of the invention, as it is intended to be encompassed by the following claims and their legal equivalents.

What is claimed is:

1. A method for enhancing the performance of a marginal employee comprising the steps of:
(a) an employer identifying a marginal employee;
(b) the employer determining whether the employee lacks motivation or lacks an ability to meet one or more job requirements;
(c) the employer identifying further training that would give the marginal employee the ability to meet the one or more job requirements;
(d) the employer defining at least one goal for enhanced performance of the marginal employee;
(e) the employer defining a time period within which the marginal employee should achieve the at least one goal for enhanced performance;
(f) the marginal employee making a record of the marginal employee's understanding of the one or more job requirements;
(g) the employer discussing with the marginal employee the one or more job requirements and the marginal employee's understanding of the one or more job requirements;
(h) the employer communicating to the marginal employee the at least one goal for enhanced performance and the time period within which the marginal employee should achieve the at least one goal for enhanced performance;
(i) the employer communicating to the marginal employee one or more possible outcomes;
(j) the employer obtaining from the marginal employee an acknowledgement of the at least goal for enhanced performance and the time period within which the marginal employee should achieve the at least one goal for enhanced performance;
(k) the employer making available the further training that would give the marginal employee the ability to meet the one or more job requirements;
(l) the employer monitoring the marginal employee's performance over the time period;
(m) the employer determining whether the at least one goal for enhanced performance was achieved during the time period;
(n) the employer determining whether an extension of the time period for the employee to achieve the at least one goal for enhanced performance is appropriate; and
(o) the employer determining an appropriate outcome for the marginal employee.

2. The method according to claim 1 wherein the step of determining whether an extension of the time period for the employee to achieve the at least one goal for enhanced performance is appropriate comprises the sub-steps of:
(a) the employer considering the marginal employee's effort on a numerical scale;
(b) the employer considering the marginal employee's proximity to meeting the at least one goal for enhanced performance;
(c) the employer considering the marginal employee's steadiness of improvement in performance;
(d) the employer considering the marginal employee's ability to meet the one or more job requirements;
(e) the employer considering the marginal employee's willingness to meet the one or more job requirements;
(f) the employer determining whether an appropriate time period for an extension exists;
(g) the employer determining whether at least one extended goal for enhanced performance exists;
(h) the employer determining whether the at least one extended goal for enhanced performance and the extension of the time period for achieving the at least one goal for enhanced performance have been documented;
(i) the employer determining whether the at least one extended goal for enhanced performance and the extension of the time period for achieving the at least one goal for enhanced performance have been discussed with the marginal employee;
(j) the employer determining whether the extension would be consistent with the employer's treatment of other marginal employees;
(k) the employer determining whether any additional training is recommended for the marginal employee;
(l) the employer determining whether the additional recommended training is available;
(m) the employer determining whether the marginal employee is willing to participate in the extension of the time period for the marginal employee to achieve the extended at least one goal for enhanced performance;
(n) the employer determining whether the marginal employee has agreed to the extended at least one goal for enhanced performance and the extension of the time period for achieving the at least one goal for enhanced performance;
(o) the employer determining whether any costs of the extension of the time period and the additional training are feasible;
(p) the employer determining whether an advantage to the extension of the time period exists; and
(q) the employer determining whether there was a defect in the at least one goal for the enhanced performance of the marginal employee, the time period for achieving the at least one goal or the training provided.

3. The method according to claim 1 wherein the possible outcomes comprise a termination, a reassignment and a retention.

4. The method according to claim 1 further comprising the step of documenting each step of the method.
